(19) United States
(12) Patent Application Publication
(10) Pub. No.: US 2017/0148428 A1
(43) Pub. Date: May 25, 2017

(54) AUDIO HEADSET WITH ACTIVE NOISE CONTROL, ANTI-OCCLUSION CONTROL AND PASSIVE ATTENUATION CANCELLING, AS A FUNCTION OF THE PRESENCE OR THE ABSENCE OF A VOICE ACTIVITY OF THE HEADSET USER

(71) Applicant: PARROT DRONES, Paris (FR)

(72) Inventors: Vu Hoang Co Thuy, Paris (FR); Marc Michau, Paris (FR); Remi Poncot, Besancon (FR)

(21) Appl. No.: 15/332,888

(22) Filed: Oct. 24, 2016

(30) Foreign Application Priority Data
Nov. 19, 2015 (FR) 1561109

(51) Int. Cl. G10K 11/178; G10L 25/78; H04R 1/10

(52) U.S. Cl. CPC G10K 11/1788; H04R 1/1008; G10L 25/78; H04R 2460/05; G10K 2210/1081; G10K 2210/3027; G10K 2210/3026

(57) ABSTRACT

The headset includes an active noise control with an internal microphone (28) and an external microphone (32). A processor (42) comprises a feedback branch (46), adjusted so as to attenuate the low frequencies corresponding to a component of a voice signal transmitted by bone conduction, and a feedforward branch (58) adjusted so as to compensate for the attenuation introduced by the feedback filtering and the passive acoustic attenuation introduced between the outside and the inside of the headset. A voice activity detector (60) operates a dynamic switching between two couples (H_{FB}, H_{FF}) of different transfer functions applied to the feedback (46) and feedforward (58) functions. This allows rendering in the most natural way possible to the user all the external sounds, including his own voice.

The invention relates to a unit of the “microphone-headset” type, comprising an audio headset provided with an “active noise control” system, combined with a microphonic set adapted to pick up the voice of the headset wearer.

The audio headset generally comprises two earphones linked by a headband. Each earphone comprises a closed casing housing a sound reproduction transducer and intended to be applied around the user's ear with interposition of a circumaural pad isolating the ear from the external sound environment.

There also exist earphones of the “intra-aural” type, with an element to be placed in the auditory canal, hence having no pad surrounding or covering the ear, or also “intra-concha” type, where this elements protrudes in the hollow of the ear auricle beyond the auditory canal.

In the following, it will mainly be referred to earphones of the “headset” type with a transducer housed in a casing surrounding the ear (“circumaural” headset) or in rest on the latter (“supra-aural” headset), but this example must not be considered as being limitative, as the invention can also be applied, as will be understood, to earphones of the “intra-aural”, “intra-concha” type, or the like.

In any case, the headset may be used for listening an audio source (for example, music) coming from an apparatus such as MP3 player, radio, smartphone, etc., to which it is connected by a wireline link or by a wireless link, in particular a Bluetooth link (registered trademark).

Thanks to the microphone set, it is also possible to use this headset for functions of communication such as “hands-free” phone functions, as a complement of the audio source listening. The headset transducer then reproduces the voice of the remote speaker with which the headset wearer is in conversation.

Such a combined micro-headset unit is described for example in the EP 2 518 724 A1, EP 2 930 942 A1 and EP 2 945 399 A1 (all three in the name of Parrot).

When the headset is used in a noisy environment (metro, busy street, train, plane, etc.), the wearer is partially protected from the noise by the headset earphones, which isolate him thanks to the closed casing and to the circumaural pad. Indeed, due to its mechanical structure, the headset passively attenuates the level of ambient noise as a low-pass filter, attenuating more strongly the high frequencies. The level of attenuation is directly linked to the mechanical parameters of the headset, essentially the mass and stiffness thereof. Documents such as EP 0 414 479 A2 and U.S. Pat. No. 8,358,799 B1 describe various techniques of optimization of this passive filtering function.

However, this purely passive protection is only partial, a part of the sounds, in particular in the low part of the frequency spectrum, being able to be transmitted to the ear through the earphone casing, or via the wearer's skull.

This is for this reason that have been developed so-called techniques of “Active Noise Control” or ANC, whose principle consists in picking up the incident noise component and to superimpose, temporally and spatially, to this noise component an acoustic wave that is ideally the inverted copy of the pressure wave of the noise component. The matter is to create that way a destructive interference with the noise component and to reduce, ideally to neutralize, the variations of pressure of the spurious acoustic wave.

The EP 2 597 889 A1 (Parrot) describes a headset, provided with such an ANC system combining filtering operations of the closed-loop feedback and the open-loop feedforward types. The feedback filtering path receives a signal collected by a microphone placed inside the earphone casing near the ear, picking up the sound produced by the transducer and the residual noise, not neutralized, still perceptible in the cavity of the earphone. The feedforward filtering path uses the signal picked up by an external microphone collecting the spurious noise existing in the immediate environment of the headset wearer. Finally, a third filtering path processes the audio signal coming from the music source to be reproduced. The output signals of the three filtering paths are combined and applied to the transducer to reproduce the music source signal associated with a suppression signal of the surrounding noise (the signal of the internal microphone, from which is subtracted the audio signal of the music source, constituting an error signal for the feedback loop of the ANC system).

But, in certain situations, the attenuation of the surrounding noise by the ANC system may be troublesome, then making the use of the headset unsuited:
hence, the user sometimes wishes to perceive naturally his own voice: for example, when the headset offers a “hands-free” phone function, the headset wearer wishes being able to converse with the remote speaker, or with a person physically present near him, by perceiving his own voice in the same way as if he were not wearing a headset;
in other situations, the user wishes to perfectly perceive his environment, in order to hear for example the car circulation, to evaluate the distance of the vehicles or to hear an alarm signal, a message broadcast by the driver of a public transit service, etc.

These two phenomena are peculiar to the headsets of the soundproof or “closed” type. Indeed, the so-called “closed” headsets are distinguished from the so-called “open” headsets by the fact that the first ones have a rear cavity that is totally closed (or partially closed, in case of presence of a vent), then creating a certain level of soundproofing, whereas the second ones have only a very low impedance at the rear of the transducer. The open headsets are only slightly soundproof and hence create only a little occlusion. But, due to their slight soundproof character, they are rarely used in a nomad way, but are rather used as a high-fidelity lounge headset or as a studio headset; moreover, the transducer radiates towards the outside a part of the sound that is reproduced, and this sound can be heard and perceived as troublesome by the surrounding people.

As regards the first above-mentioned drawback, i.e. the perception of his own voice by the user, when a person emits a speech component, a vibration propagates from the vocal cords to the pharynx and to the oronasal cavity, where is it modulated, amplified and articulated. The mouth, the soft palate, the pharynx, the sinus and the nasal fossa serve as a resonating chamber for this sound, and their walls being elastic, they themselves vibrate and these vibrations are transmitted by internal bone conduction directly to the subject's ear.

In the absence of a headset, when the ear is not obstructed, the voice sounds transmitted by bone conduction to the auditory canal are very weakly perceived, because they are evacuated towards the outside of the ear, which has the lowest acoustic impedance with respect to that of the tympanic membrane.

On the other hand, when a headset is worn, this headset totally or partially obstructs the auditory canal, i.e. it introduces a high acoustic impedance at the external end of the auditory canal: this impedance causes the putting in resonance within the auditory canal of the sounds transmitted by bone conduction, and hence an amplification of the low-frequency part of the voice signal with respect to a situation in which the auditory canal is open, with a rising of the level of the order of 20 dB below 500 Hz. The user then perceives his voice in a far more muted way.

This phenomenon, hereinafter denoted “occlusion”, affects in a known manner the wearers of hearing aids and various solutions have already been proposed to remedy this in this context.

A passive solution consists in providing an event of pressure balance between the cavity of the auditory canal and the external environment, as a tube passing through the auditory prosthesis.

Active solutions have also been proposed, using a microphone and a feedback filtering, as in the US 2006/0120545 A1 (U.S. Pat. No. 7,477,754 B2), with possibly an adaptive adjustment, as in the WO 2006/037156 A1 (EP 1 795 045 B1): when the feedback filtering is activated to suppress the occlusion effect, the feedforward filtering branch is then modified so as not to be influenced by the feedback filtering introduced.

Generally, if those various methods allow suppressing the occlusion effect, they do not allow rendering the external sounds to the user as if he were not wearing a headset.

As regards the possibility, in certain circumstances, to perceive the sound environment despite the wearing of the headset, various techniques have been proposed as, for example, in the US 2009/0034748 A1, which adapt the level of active attenuation of the feedforward branch as a function of an automatic evaluation of external events. In a secured mode, the level of attenuation may be reduced for example following the detection of a level of external noise exceeding a predefined threshold, in order to allow the user to perceive more clearly this external environment. This functionality is also proposed by the US 2010/0272284 A1 (U.S. Pat. No. 8,155,334 B2) where, following a command by the user, only the frequencies located outside the passband of the speech remain attenuated, so as to allow the user to hear an external speaker. In a simpler implementation, it is also possible, by pressing a button, to suppress both the active attenuation of the noise and the music broadcast by the earphones to better perceive the environment.

But these various techniques, if they allow compensating in part the passive attenuation of the headset, are with no effect on the phenomenon of occlusion.

The difficulty of the problem comes from the fact that the workarounds to the two above-mentioned drawbacks (amplification of his own voice by the user and variable attenuation of the external noise) give rise to contradictory solutions if they are implemented by static methods.

For example, if it is wished to attenuate the amplification of the own voice of the user, it will be typically necessary to attenuate (via the feedback/feedforward filtering operations) by at least 15 dB the frequencies below 300 Hz. And in this case, the correction will also act on the external noises located in these frequencies, which are generally spurious noises that are wished to be suppressed (noise of car or train rolling), so that by compensating for one of these phenomena, the automatic attenuation of the spurious noises will be degraded.

The US 2014/0126736 A1 (U.S. Pat. No. 8,798,283 B2) proposes a solution in which the feedback filter used in a “natural ambience restitution” mode (where the user wishes to perceive the sound environment) is the same as that of a so-called “noise cancellation” mode (where the headset operates in a conventional ANC mode), whereas the feedforward filter is modified with respect to the ANC mode in order to reach at best a so-called “natural ambience” target-response as it would be without the wearing of a headset. The feedback filter is mainly efficient above 1000 Hz and attenuates the occlusion effect, but also all the external noises. To compensate for that, the feedforward filter reinjects the external noise at once in all the band of audible frequencies (above and below 1 kHz).

This solution has however two major drawbacks:
on the one hand, the presence of a feedback filter of high gain (generally more than 20 dB in a noise cancelling mode) has for effect to produce a significant audible hiss, typical of the ANC systems, due to the noise introduced by the electric system of the microphone, and by the analog/digital converter in the case of a digital system. On the other hand, reinjecting the external noise via the feedforward filter will also necessitate a high gain in this branch to compensate for the attenuation of the feedback filter, which will introduce an additional hiss;
a second drawback comes from the fact that, by reinjecting the noise via a high-gain feedforward filter, the system becomes very sensitive to the effects generated by the wind: indeed, the signal produced by the external microphone used for the feedforward filtering will be degraded in the presence of wind, because the latter disturbs the displacement of the microphone membrane, in particular in the frequencies located above 1 kHz. This degradation produces all the more significant effects that the feedforward filter i) has a high gain and ii) cooperates over an extended range of frequencies—which is precisely the case herein.

The US 2014/0126734 A1 describes a variant of the above-mentioned US 2014/0126736 A1, where it is provided an automatic detection of the presence or the absence of speech by analysis of the acoustic waves picked up by the internal feedback microphone (which, due to a transmission by bone conduction between the larynx and the auditory canal, picks up increased acoustic pressure when the use speaks). In case of detected speech, the anti-occlusion system is activated, with modification of the feedforward and feedback filter responses. But the drawbacks exposed hereinabove remain unsolved.

The object of the invention is to remedy these different drawbacks and limitations, by proposing a technique allowing, by purely electronic and digital means, transforming a headset of the “closed” type to simulate an “open” headset, with:
suppression of the occlusion phenomenon when the user speaks, so that he perceives naturally his voice as if he were not wearing a headset and no longer in a muted way; and
active suppression, at will, of the passive soundproofing of the headset, so that the user has the faculty either to use normally his closed headset, with the accompanying soundproofing, or to “open” the closed headset, by purely electronic and digital means by activating a function that allows him to faithfully perceive the environment to listen to a message broadcast by a loudspeaker, to better hear the car circulation, etc.

As will be seen, the present invention is based on the use of a vocal activity detection system controlling an adapted adaptation of the couples of feedback and feedforward filters in the presence or in the absence of voice detected.

The invention applies to all the closed headsets, whether they are of the “circumaural”, “supra-aural” type, or to the earphones of the “intra-aural” type, comprising a hybrid ANC active noise control, including both a feedback filtering path and a feedforward filtering path.

More precisely, the invention has for object such a headset comprising, in a manner known in itself from the above-mentioned US 2014/0126734 A1, two earphones each including a transducer for sound reproduction of an audio signal to be reproduced, this transducer being housed in an ear acoustic cavity.

This headset comprises an active noise control system with:
an internal microphone, placed inside the acoustic cavity and adapted to deliver a first signal;
an external microphone, placed outside the acoustic cavity and adapted to deliver a second signal, and
a digital signal processor, comprising:
   a closed-loop feedback branch, comprising a feedback filter adapted to apply a feedback filtering transfer function H_{FB} to said first signal delivered by the internal microphone;
   an open-loop feedforward branch, comprising a feedforward filter adapted to apply a feedforward filtering transfer function H_{FF} to said second signal delivered by the external microphone; and
   mixing means, receiving as an input the signal delivered by the feedback branch at the exit of the feedback filter and by the feedforward branch at the exit of the feedforward filter, as well as a possible audio signal to be reproduced, and delivering as an output a signal adapted to pilot the transducer.

This headset further comprises means adapted to operate an anti-occlusion control and a cancellation of the passive attenuation introduced by the headset, comprising:
means for detecting the voice activity of the headset user, adapted to discriminate between a situation of presence and a situation of absence of voice activity of the headset user; and
means for dynamic switching, selectively as a function of the current result of the voice activity detection, between two couples of different transfer functions {H_{FB},H_{FF}} applied to the feedback and feedforward filters.

Characteristically of the invention, in the absence of voice activity, the parameters of the feedforward filtering transfer function applied to the feedforward filter by the dynamic switching means to operate said cancellation of the passive attenuation are chosen so as to provide, in a range of frequencies comprised at least between 100 and 300 Hz, a first feedforward filtering gain lower than a second feedforward filtering gain of the feedforward filtering transfer function applied to the feedforward filter by the dynamic switching means to operate said anti-occlusion control in the presence of voice activity.

Conversely, in the presence of vocal activity, the parameters of the feedback filtering transfer function applied to the feedback filter by the dynamic switching means to operate said anti-occlusion control may be chosen so as to provide, in a range of frequencies comprised at least between 100 and 300 Hz, a first feedback filtering gain higher than a second feedback filtering gain of the feedback filtering transfer function applied to the feedback filter by the dynamic switching means in the absence of voice activity. The first feedforward filtering gain in the absence of voice activity may in particular be of at most 8 dB for the frequencies below 1 kHz, and the second feedforward filtering gain in the presence of voice activity may in particular be of at least 10 dB in a range of frequencies comprised at least between 100 and 300 Hz.

The first feedback filtering gain in the presence of voice activity may in particular be of at least 15 dB in a range of frequencies comprised at least between 100 and 300 Hz, and the second feedback gain in the absence of voice activity may in particular be of at most 5 dB for the frequencies comprised between 200 Hz and 1 kHz.

Moreover, the parameters of the feedforward and feedback filtering transfer functions applied by the dynamic switching means to the feedforward and feedback filters in the absence of voice activity may be chosen so as to provide together, for the frequencies below 1 kHz, a hiss lower than that provided by the feedforward and feedback filtering transfer functions applied by the dynamic switching means in the presence of voice activity.

In particular, the parameters of the feedforward and feedback filtering transfer functions applied by the dynamic switching means to the feedforward filters may be chosen so as to provide together, for the frequencies below 1 kHz, a final restitution of the external noises close to that provided by the feedforward and feedback filtering transfer functions applied by the dynamic switching means in the absence of voice activity, so as to avoid an audible discontinuity upon a switching.

In an advantageous, particular embodiment of the invention, the feedforward filter is one between a plurality of selectively switchable preconfigured feedforward filters. The digital signal processor then further comprises: means for analysing said first signal (e) delivered by the internal microphone, adapted to verify whether or not current characteristics of this first signal verify a set of predetermined criteria; and selection means, adapted to select one of the preconfigured feedforward filters as a function of the result of the verification of the first set of criteria performed by the analysis means on the characteristics of the first signal.

The current characteristics of the first signal may in particular comprise values of energy of this first signal in a plurality of bands of frequencies, the predetermined criteria comprising a series of respective thresholds with which are compared said values of energy.

Finally, the set of predetermined criteria may further comprise a criterion of presence or not of an audio signal to be reproduced. Two different series of respective thresholds are then provided, with which are compared said values of energy, one or the other of these two series being selected according to whether or not an audio signal to be reproduced is present.

An exemplary embodiment of the invention will now be described, with reference to the appended drawings in which the same references denote identical or functionally similar elements throughout the figures.

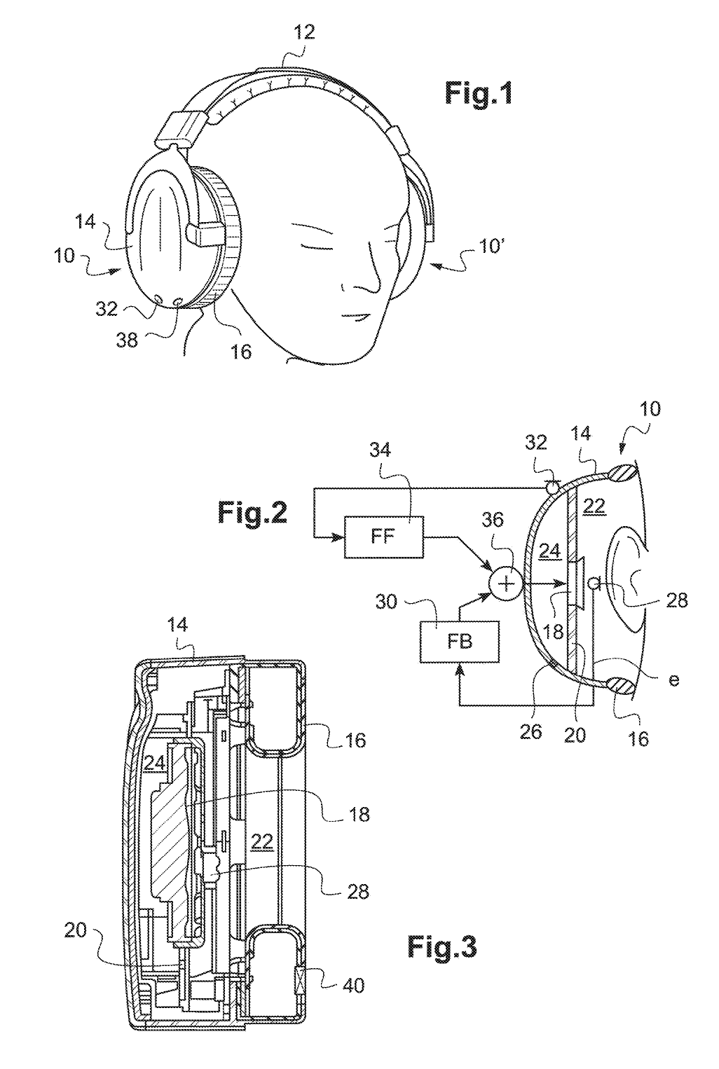

FIG. 1 generally illustrates a combined microphone-headset unit placed on the head of a user.

FIG. 2 is a schematic representation showing the different acoustic and electrical signals as well as the essential functional blocks involved in the operation of an active noise control audio headset.

FIG. 3 is a sectional view in elevation of one of the earphones of the headset according to the invention, showing the configuration of the various mechanical elements and electromechanical members thereof.

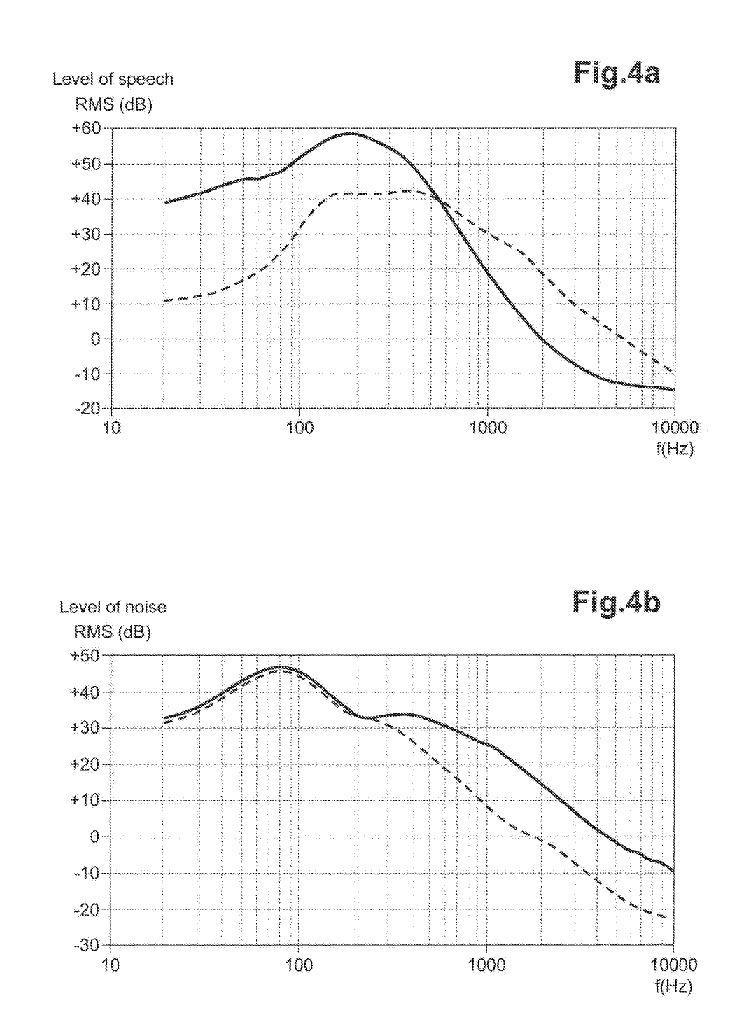

FIGS. 4a and 4b illustrate the spectra of acoustic signals, of speech and surrounding noise, respectively, obtained with and without a headset worn by the user and in the absence of any electronic processing of the signal.

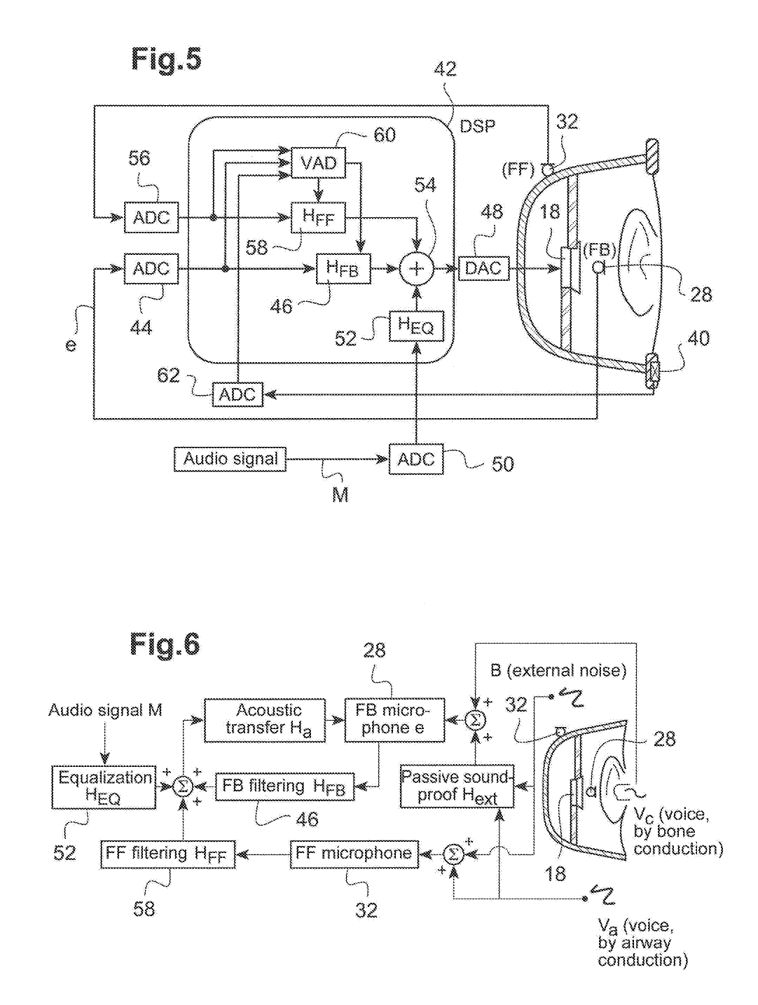

FIG. 5 schematically illustrates, as functional blocks, the main elements allowing the making of the anti-occlusion processing according to the invention.

FIG. 6 is a flow diagram illustrating the way the different signals collected by the device are combined together, as well as the transfer functions applied.

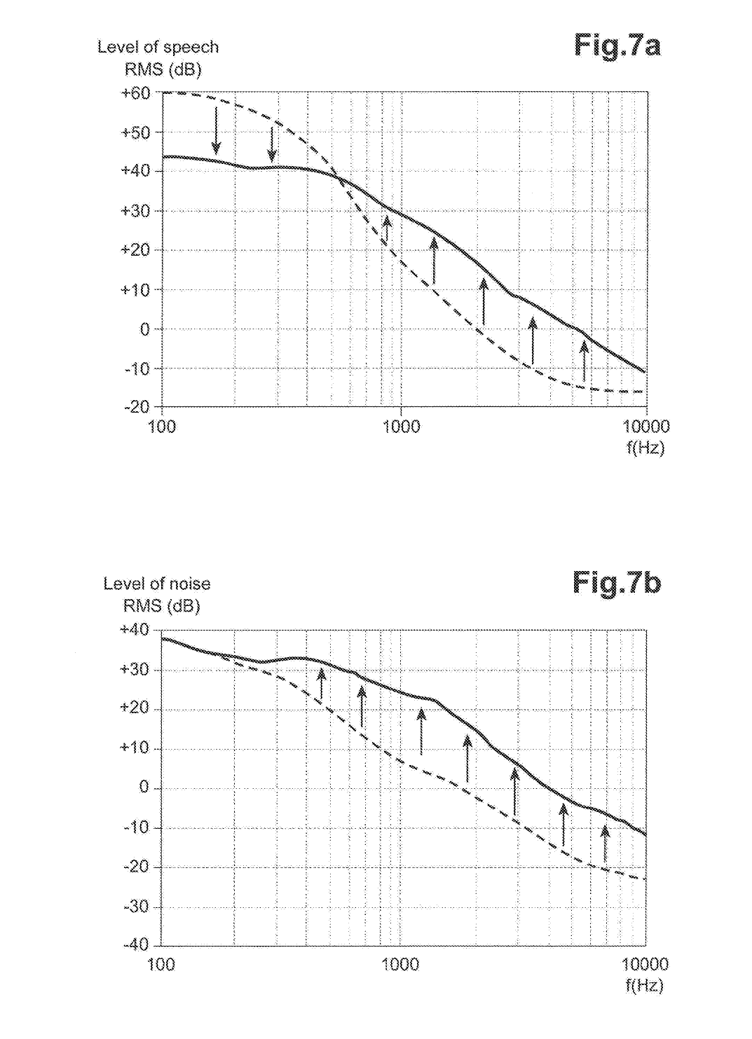

FIGS. 7a and 7b illustrate the spectra of acoustic signals, of speech and surrounding noise, respectively, picked-up at the ear of the headset wearer, with and without the electronic processing according to the invention allowing obtaining the effect of anti-occlusion and passive attenuation cancelling.

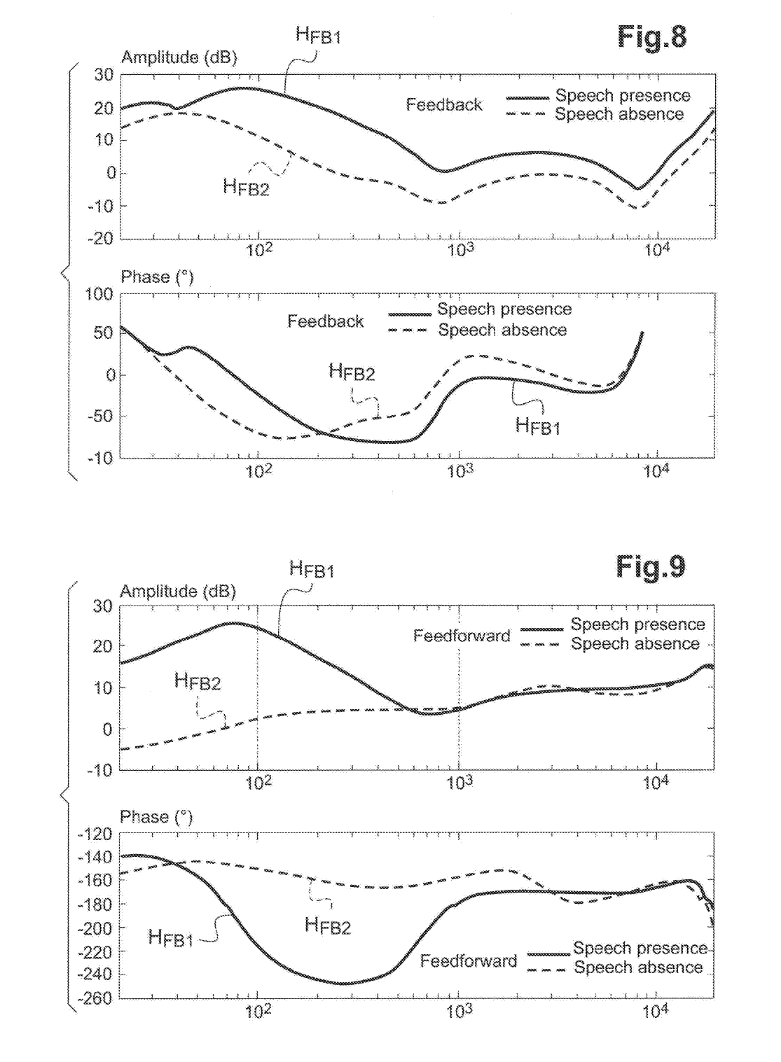

FIG. 8 shows, in amplitude and phase, the diagram of a feedback filter implemented by the invention, in a situation of presence of speech and in a situation of absence of speech.

FIG. 9 illustrates, in amplitude and phase, the diagram of a feedforward filter implemented by the invention, in a situation of presence of speech and in a situation of absence of speech.

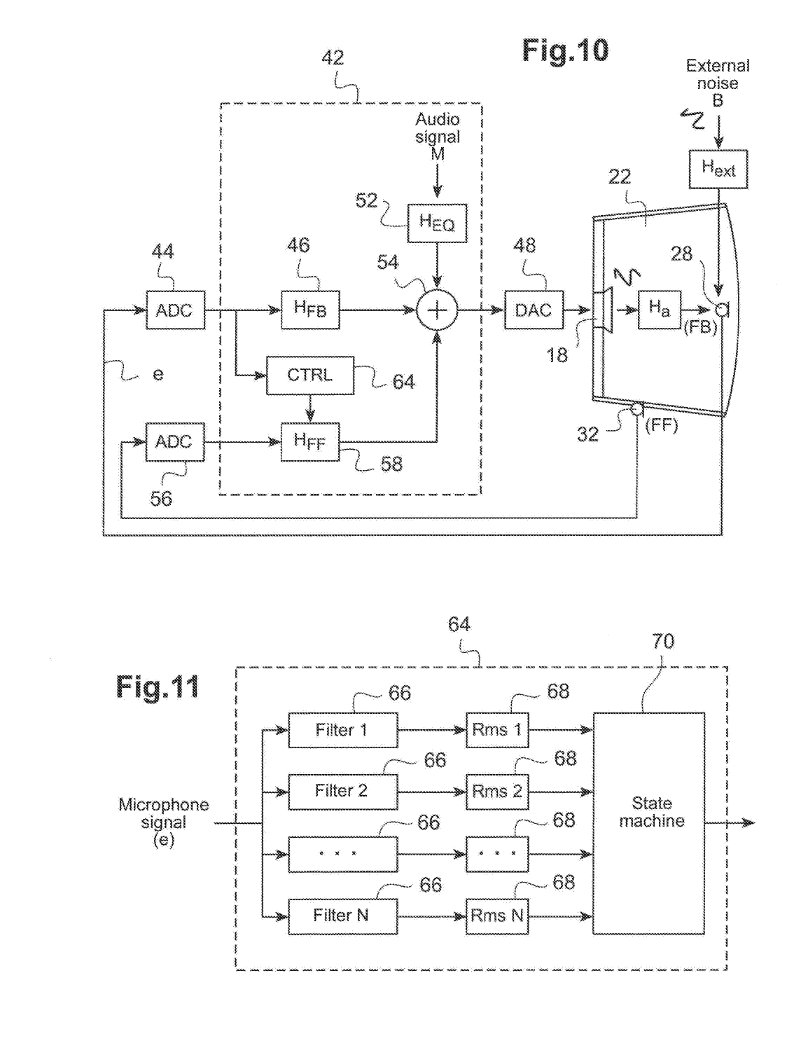

FIG. 10 illustrates schematically, as functional blocks, the main elements allowing, in an improvement of the invention, adapting dynamically the anti-occlusion processing as a function of the ambient noise type and level.

FIG. 11 illustrates more precisely the elements implementing the function of analysis of the microphone signal collected on the feedback branch and of selection of the filters to be applied to the signals processed in the feedforward branch.

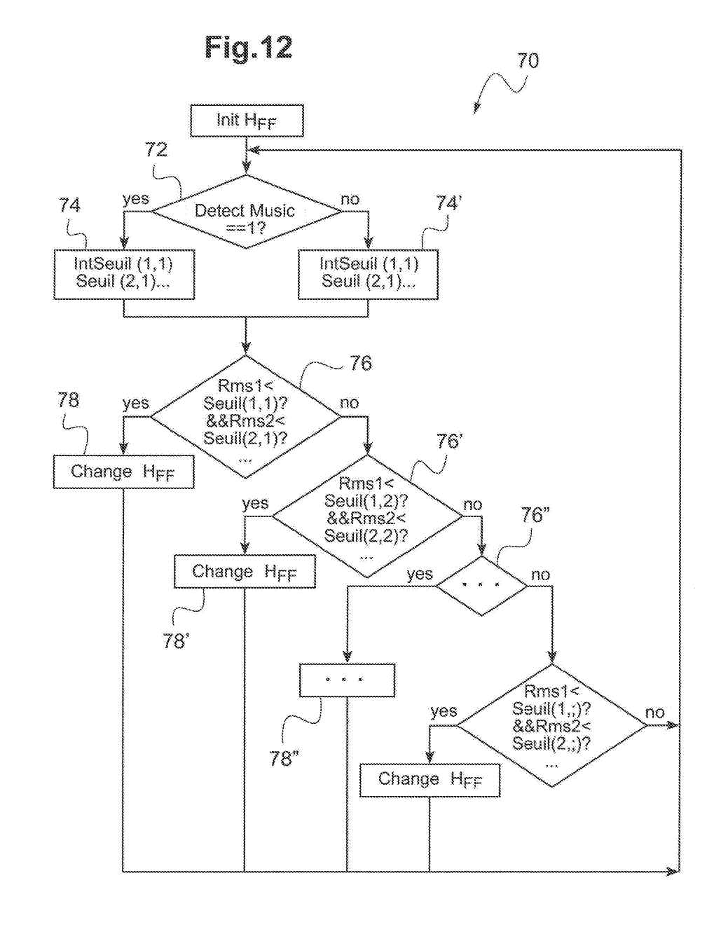

FIG. 12 is a flow diagram describing the operation of the state machine of a function of analysis and selection of FIG. 11.

An example of implementation of the technique of the invention will now be described.

In FIG. 1 is shown a combined audio microphone-headset unit, placed on the head of the user thereof. The headset includes, in a manner conventional per se, two earphones 10, 10′ linked by a holding headband 12, and each earphone comprises an external casing 14 coming on the users ear contour, with interposition between the casing 14 and the ear periphery of a circumaural flexible pad 16 intended to ensure a satisfying tightness, from the acoustic point of view, between the ear region and the external sound environment.

As indicated in introduction, this example of configuration of the “headset” type with a transducer housed in a casing surrounding the ear or in rest on the latter must not be considered as being limitative, as the invention can also be applied to intra-aural or intra-concha earphones comprising an element to be placed in the auditory canal, hence earphones devoid of casing and pad surrounding or covering the ear.

FIG. 2 is a schematic representation showing the different acoustic and electrical signals as well as the essential functional blocks involved in the operation of an ANC (active noise control) audio headset.

The earphone 10 encloses a sound reproduction transducer 18, hereinafter simply called “transducer”, carried by a partition 20 defining two cavities, i.e. a front cavity 22 on the ear side and a rear cavity 24 on the opposite side.

The front cavity 22 is defined by the inner partition 20, the wall 14 of the earphone, the pad 16 and the external face of the user's head in the ear region. This cavity is a closed cavity, except the inevitable acoustic leakages in the region of contact of the pad 16. The rear cavity 24 is a closed cavity, except for an acoustic vent 26 allowing obtaining a reinforcement of the low frequencies in the front cavity 22 of the earphone.

For the active noise control, an internal microphone 28 is placed the closest possible to the auditory canal of the ear to pick up the acoustic signal in the internal cavity 22, a signal in which is present a residual noise component that will be perceived by the user. The neutralization of the noise being never perfect, this internal microphone allows obtaining a signal of error e that is applied to a closed-loop feedback filtering branch 30.

On the other hand, one (or several) external microphone(s) 32 is(are) placed on the casing of the headset earphones, to pick up the surrounding acoustic signals present outside the earphone. The signal collected by the external microphone 32 is applied to a feedforward filtering stage 34 of the active noise control system. The signals coming from the feedback branch 30 and from the feedforward branch 34 are combined in 36 to pilot the transducer 18.

The transducer 18 may further receive an audio signal to be reproduced, coming from a music source (personal music player, radio, etc.), or a voice signal coming from a remote speaker in a phone application. As this signal undergoes the effects of the closed loop that distorts it, it will have to be pre-processed by an equalization so as to present the desired transfer function, determined by the gain of the open loop and the target response without active control.

The headset further includes another external microphone 38 (FIG. 1) intended to communication functions, in particular to ensure “hands-free” phone functions. This additional external microphone 38 is intended to pick up the voice of the headset wearer, it does not intervene in the active control of the noise and, in the following, it will be considered as an external microphone used by the ANC system only the microphone 32 dedicated to the active noise control.

FIG. 3 illustrates, in a sectional view, an exemplary embodiment of the various mechanical and electroacoustic elements schematically shown in FIG. 2 for one of the earphones 10 (the other earphone 10′ being made identically). We can see therein the frame 20 dividing the inside of the casing 14 into a front cavity 22 and a rear cavity 24 with, mounted on this frame, the transducer 18 and the internal microphone 28 carried by a grid holding the latter in the vicinity of the auditory canal of the user.

A vibration sensor 40 (accelerometer sensor) is advantageously incorporated to the pad 16 of one of the earphones of the headset so as to come into contact with the user's jaw through the material covering this pad. It hence plays a role of physiological sensor allowing collecting voice vibrations at the cheek and the temple, vibrations that have the characteristic to be, by nature, very little corrupted by the surrounding noise: indeed, in the presence of external noises, the tissues of the cheek and the temple almost not vibrate and that, whatever the spectral composition of the external noise.

The interest of such a vibrations sensor 40 comes from the fact that it allows obtaining a signal in the low frequencies (due to the filtering generated by the propagation of the vibrations up to the temple), and that this signal is naturally devoid of spurious noise component, whereas the noises generally met in a usual environment (street, metro, train . . . ) are predominantly concentrated in the low frequencies.

FIGS. 4a and 4b illustrate the spectra of the acoustic signals, of speech and surrounding noise, respectively, collected at the ear with and without a headset worn by the user and in the absence of any electronic processing of the signal.

More precisely, FIG. 4a illustrates the spectrum of a voice signal of the user, measured at the place of his ear: the characteristic in dashed line corresponds to a situation in which no headset is worn, and the characteristic in full line is that in which a headset is worn, but with no anti-occlusion processing according to the invention: it is to be noted that in the low frequencies, up to about 550 Hz, the voice signal is amplified up to +20 dB due to the phenomenon of occlusion. On the contrary, beyond this frequency, the voice signal is mainly transmitted by airway, and it is attenuated by the order of −15 dB by the passive mechanical elements of the headset.

FIG. 4b illustrates the spectra of a pink noise signal generated outside the headset, and measured at the place of the user's ear. The characteristic in full line corresponds to the situation in which no headset is worn, and the characteristic in dashed line to that in which a headset is worn, but still with no anti-attenuation processing according to the invention: it is to be noted that the external noise is attenuated by about −15 dB beyond a frequency of about 200 Hz.

FIG. 5 schematically illustrates, as functional blocks, the ANC active noise control and anti-occlusion and anti-attenuation processing system according to the invention. It is advantageously an ANC system of the digital type, implemented by a digital signal processor (DSP) 42. It will be noted that, although these schemes are presented as interconnected circuits, the implementation of the functions is essentially software-based, this representation being only illustrative.

We can see therein the feedback branch whose principle has been described hereinabove with reference to FIG. 2, with digitization by means of an analog-digital converter (hereinafter “ADC”) 44 of the error signal e picked up by the internal microphone 28. This digitized error signal is processed by a filter 46, then converted into an analog signal by a digital-analog converter (hereinafter “DAC”) 48 in order to be rendered by the transducer 18 in the cavity 22 of the earphone 10. The reproduced signal is possibly combined to an audio signal M (for example a music signal, or the voice signal of a remote speaker when the phone function is active) that, after possible conversion by an ADC 50 and equalization in 52, is combined in 54 to the noise cancellation signal for conversion by the DAC 48 and reproduction by the transducer 18.

We can also see the feedforward branch whose principle has been described hereinabove with reference to FIG. 2, with digitization by means of an ADC 56 of the signal picked up by the external microphone 32. The digitized signal is processed by a filter 58, then combined in 52 to the signal of the feedback branch and to the possibly present equalized audio signal.

The DSP 42 moreover implements a voice activity detector (hereinafter “VAD”) 60, whose function consists in analysing the voice activity of the headset user based on the digital signals provided by a sensor that may be:
the internal microphone 28, and/or
the external microphone 32, and/or
the accelerometer (physiological sensor) 40.

The voice activity analysis may implement algorithms of known type, for example those described in the WO 2007/099222 A1 (Parrot SA) and EP 2 772 916 A1 (Parrot SA), to which reference may be made for further details. Those algorithms deliver in real time, as a function of the analysed signals, a value of probability of presence (or absence) of speech comprised between 0 and 100% for each frame of the digital signal analysed. The comparison of the current value of this probability with a given, predetermined or dynamic, threshold allows obtaining for each frame a binary indication of presence/absence of speech in the collected signal.

The voice activity detector 60 pilots the feedback 46 and feedforward 58 filters so as to modify the characteristics according to whether or not we are in presence of a voice activity of the headset user, i.e. according to whether or not the latter is speaking, a situation typical of a “hands-free” phone conversation with a remote speaker, or a conversation with a speaker physically present in the vicinity.

FIG. 6 is a flow diagram illustrating the way the different signals collected by the device are combined together, as well as the transfer functions applied.

The signal picked up by the external microphone 32 (feedforward microphone FF) is formed of the combination of the following elements:
the surrounding external noise, noted B in the following; and
the user voice signal transmitted by airway, noted Vₐ.

The signal picked up by the internal microphone 28 (feedback microphone FB) is formed of the combination of the following elements:
the external noise passively attenuated by the mechanical elements of the headset, i.e. B*Hₑₓₜ, Hₑₓₜ being the transfer function between the external source and the internal microphone 28;
the voice signal, i) a part of which, noted V_{c}, is transmitted by bone conduction up to the auditory canal, and ii) the other part of which Vₐ is transmitted by airway and passively attenuated by the mechanical elements of the headset, i.e. Vₐ*Hₑₓₜ; and
the signal generated by the transducer 18, combining the equalized audio signal M and the signals coming from the feedforward 58 and feedback 46 filters, the transfer functions of which will be noted H_{FF} and H_{FB}, respectively.

Moreover, the accelerometer 40 picks up on several axes a signal Aₘ coming from micro-movements of the jaw.

Characteristically, the principle of the invention consists in operating a differentiated adjustment of the filters H_{FB} and H_{FF} as a function of the presence or the absence of a voice activity, so as to optimize the operation. Firstly, in the presence of voice activity, it is advisable to operate an adjustment of two feedback 46 and feedforward 58 filters, to:
favour the reduction of the level of the voice signal V_{c} transmitted by bone conduction to such a level that it would be heard with no headset, in other words to cancel V_{c}; and
in the same time, increase the level of the voice signal Vₐ transmitted by airway to such a level that it would be heard with no headset by cancelling the passive attenuation linked to the mechanical elements by compensation for the effect of Hₑₓₜ.

The couple of filters H_{FB} and H_{FF} adjusted for this first situation will be noted H_{FB1} and H_{FF1}.

On the other hand, in the absence of voice activity, it will be searched to:
favour the increase of the external noise B to such a level that it would be perceived if the user were not wearing a headset, by compensating for the effect of Hₑₓₜ by another couple of filters H_{FB} and H_{FF}.

The couple of filters H_{FB} and H_{FF} adjusted for this second situation will be noted H_{FB2} and H_{FF2}.

The couple of filters H_{FB2} and H_{FF2} will have to guarantee:
a level of acoustic hiss lower than that of the couple H_{FB1} and H_{FF1}, typically a level lower by at least 10 dB; and
an immunity to wind that is better than that of the couple H_{FB1} and H_{FF1}, typically such an immunity that the signal/wind noise ratio SWNR is improved by at least 12 dB.

SWNR is defined as being the signal/wind noise ratio felt by the user or measured by the internal microphone when an anti-occlusion or attenuation cancellation mode is activated.

The invention is based on the differentiation of the signals picked up by the feedback internal microphone 28 and those picked up by the feedforward external microphone 32.

Indeed, the first one is sensitive to the amplification in the low frequencies linked to the voice signal transmitted to the auditory canal by bone conduction, whereas this amplification, linked to the occlusion of the canal, is not perceived by the feedforward external microphone 32, which is mounted on the external part of the headset.

From a mathematical point of view, it may be written:

$$e = \frac{1}{1 - {H}_{a} {H}_{FB}} ( ( {H}_{ext} + {H}_{FF} {H}_{a} ) * ( B + {V}_{a} ) + {V}_{c} ) + \frac{{H}_{a}}{1 - {H}_{a} {H}_{FB}} {H}_{EQ} M$$

Hₐ being the acoustic transfer function between the transducer 18 and the feedback microphone 28 and M being the audio signal.

The results obtained by the implementation of the invention are shown by the arrows in FIGS. 7a and 7b, which are spectra of acoustic signals, of speech and surrounding noise, respectively, picked up at the ear of the headset wearer, with (in full line) and without (in dashed line) the electronic processing of the invention allowing obtaining in an optimized manner the effect of anti-occlusion and passive attenuation cancelling.

To attenuate the occlusion effect (FIG. 7a), the processing applies the couple of filters H_{FF1} and H_{FB1}: the feedback filter H_{FB1} has for effect to attenuate this occlusion effect, and the feedforward filter H_{FF1} operates i) the reinjection of the low frequencies of external noise and voice that had been attenuated by the feedback filter, in addition to ii) the reinjection of these sounds in the higher frequencies, which had been attenuated by the passive mechanical elements of the headset (FIG. 7b).

In this mode, i.e. in the case where a presence of the user's voice has been detected, the hiss due to the electric noise of the microphones, as well as the sensitivity to wind, are higher than what they are in the other mode, i.e. in the case where no user's voice has been detected.

On the other hand, in the absence of detection of voice activity of the user, a couple of filters H_{FB2} and H_{FF2} with lower gains will allow reinjecting the external sounds over the whole band of the audible frequencies, with the advantage to have less hiss and less sensitivity to wind than for the couple H_{FF1} and H_{FB1}.

The two alternative operation modes, in the presence or in the absence of speech detected of the headset user, will now be described.

In the first place, the case where the VAD detects the presence of speech will be examined.

The anti-occlusion processing will then consist in a cancelling of the occlusion effect, as characterized on the curve of FIG. 4a.

To attenuate the increase of the low frequencies on the speaker's voice, a feedback control is used by setting the feedback filter H_{FB1} as follows:

$${H}_{FB 1} = {H}_{a}^{- 1} \cdot ( 1 - ( {H}_{ext} + \frac{{V}_{c}}{{V}_{a}} ) ) \qquad ( 1 )$$

FIG. 8 illustrates, in amplitude and phase, the transfer function of such a feedback filter, in full line.

As can be observed, the filtering H_{FB1} applies a maximum attenuation gain in the low frequencies, in this example an attenuation gain of at least 15 dB between 100 Hz and 300 Hz, which allows cancelling the voice signal V_{c} transmitted by bone conduction.

The filter H_{FB1} also responds to the general constraints of the feedback ANC systems, i.e. it allocates sufficient margins in gain and in phase so that the system remains stable in all the conditions of use, by hence preventing any oscillation effect (Larsen effect).

In order to compensate for the attenuation of the low frequencies contained in the ambient external noise signal and to improve the transition between the mode with speech present and without speech, a feedforward control H_{FF1} is added.

FIG. 9 illustrates, in amplitude and phase, the diagram of such a feedforward filter. In this example, the feedforward has a gain of at least 10 dB between 100 Hz and 300 Hz.

The situation in which the VAD detects no presence of speech will now be described.

The anti-occlusion processing then consists only into a reinjection of the external noise, as characterized on the curve of FIG. 4b, by means of a feedforward control.

The feedforward filter H_{FF2} is set in accordance with the following expression:

H_{FF2}=Hₐ⁻¹·(1−Hₑₓₜ) (2)

The diagram in amplitude and phase of such a feedforward filter is illustrated in dashed line in FIG. 9. In this example, the filter has a gain of at most 8 dB for the frequencies below 1 kHz.

A control by a feedback filter H_{FB2} is added in order to make less troublesome the effects such as those produced by the movements of the body of the user that wears the headset, his breath, the beats of his heart, etc.

The feedback filter H_{FB2} used for that purpose is chosen specifically for the passive attenuation cancellation mode. The desired performance for this feedback control combined with the feedforward control H_{FF2} is to reduce by about 5 dB the low frequencies (below 1 kHz) on the response measured by the internal microphone 28, in order to make more comfortable the “user experiment” in this mode.

In the illustrated example, shown in FIG. 8 is dashed line, the gain of the feedback filter H_{FB2} is of at most 5 dB for the frequencies comprised between 200 Hz and 1 kHz. It will be noted that, in the zone comprised between 100 Hz and 300 Hz, the gain of the feedback filter H_{FB2} used in the absence of speech is in particular lower than that of the feedback filter H_{FB1} used in the presence of speech, that by at least 15 dB.

A particularly advantageous embodiment of the invention, implementing an adaptive filtering avoiding the occurrence of a perceptible hiss troublesome for the user, will now be explained.

Hence, the anti-occlusion adaptive system will not only be able to automatically adapt to a situation of presence or absence of voice of the headset user, as explained hereinabove, but also to automatically adapt as a function of the nature and the level of ambient noise.

Indeed, the application of the technique described hereinabove and of the equation giving H_{FF} makes so that the higher the passive attenuation Hₑₓₜ of the headset, the higher will have to be the gain applied in the feedforward filtering branch, with for consequence that the hiss, i.e. the electric noise intrinsic to the restitution chain, may become audible when the user is in a calm environment—whereas in a noisier environment, the external acoustic noise masks the intrinsic electric noise, and the hiss is not perceived.

To compensate for this drawback, it is advantageous to complete the feedforward filtering H_{FF}, as adjusted according to the invention, by an adaptive adjustment as a function of the external noise: if the gain required by the application of the above equation giving H_{FF} is such that the electric noise becomes perceptible, then an algorithm of adaptation will adjust downwards the gain in calm environment and will restore this gain in a noisier environment, as soon as the external acoustic noise will be sufficient to mask the intrinsic electric noise of the restitution chain.

FIG. 10 schematically illustrates, as functional blocks, the main elements allowing the implementation of this improvement aiming to adapt dynamically the anti-occlusion processing as a function of the type and the level of ambient noise.

The different elements implemented are the same as those illustrated and described hereinabove with reference to FIGS. 5 and 6, with, moreover, an additional functional block 64 receiving as an input the signal produced by the internal microphone 28 of the feedback branch, and delivering as an output a control signal to the feedforward filter H_{FF} 58.

This functional block 64 may be implemented by a suitable programming of the DSP 42, in association with ADC and DAC components with a very low delay (delay of a few milliseconds) allowing the use of efficient digital filtering operations.

The adaptive adjustment of the feedforward filtering 58 may be very advantageously obtained by switching in real time a particular filtering configuration chosen among a plurality of X predetermined filtering configurations implemented within the block 58, each of these X filters allowing obtaining a more or less strong attenuation, so as to reduce the level of hiss as needed when the latter cannot be masked by the surrounding external noise.

It will be noted that the choice of a digital system allows easily programming a high number of filters (unlike an analog system, where a great number of electronic components would be necessary to have this equivalent), and above all being able to integrate an algorithmic intelligence, for example of the state machine type, allowing analysing the signal in real time and switching with a very low time of response that of the filters that will provide the better attenuation/hiss compromise.

It will be moreover noted that it is important that the switching between the different selectable filters is operated from a signal picked up by the internal microphone 28, because this is it (and not the external microphone 32), near the user's ear, that provides to the ANC system an image of the residual noise really perceived by the user, taking in particular into account the possible acoustic leakages between the inside and the outside of the earphone casing: the switching between the different filters of the feedforward branch 58, aiming to optimize the attenuation/hiss compromise, will hence depend on the level and the spectral content inside the front cavity 22 of the headset earphone.

FIG. 11 illustrates more precisely the elements implemented in the CTRL block 64 for the analysis of the signal and the selection of the filters of the feedforward branch 58.

The digitized signal e collected by the internal microphone 28 is subjected to a frequency decomposition by a battery of filters 66 (for example, Filter 1 will be able to be a low-pass filter, Filter 2 a band-pass filter, etc.) in order to calculate in 68 the energy Rmsᵢ of this signal e in each of its N frequency components.

In particular, in the framework of an active noise control by an audio headset, it is very useful to be able to study the “colour” of the surrounding noise via its spectral analysis to distinguish various significant situations: for example, for a use of the headset in a noisy environment such as in transport means (plane, train), the ratio between low and high frequencies is far more important than in a calmer environment such as in an office. It then possible to determine the power Rms₁ of the signal below 100 Hz, the power Rms₂ of the signal around 800 Hz, etc.

The obtained values Rms₁, Rms₂ . . . Rms_{N} are applied to a state machine 70, which compares these values of energy with respective thresholds, and determines as a function of these comparisons that of the X filters of the feedforward branch 58 that must be selected to modify in real time the coefficients of filtering of the transfer function H_{FF} of the anti-occlusion processing.

FIG. 12 illustrates more precisely the way this state machine 70 is operated.

The state machine decides, as a function of the current levels of energy Rms₁, Rms₂ . . . Rms_{N}, as well as the presence or not of an audio signal such as music (whose signal rendered by the loudspeaker 18 is also rendered by the internal microphone 28) if need be or not to modify the transfer function H_{FF} as it was in the initial state.

The presence or the absence of a music signal (test 72) is deduced from an indicator provided by the rendering chain, for example by a simple comparison with a threshold of the signal present on the path intended to the music. In the presence of music, the thresholds that will be used thereafter are adjusted to different respective values (blocks 74, 74′), to take into account the fact that the music plays, as the external noise, a masking role on the perception of the electric hiss introduced by the anti-occlusion control and the passive attenuation cancellation.

If the current levels of energy Rms₁, Rms₂ . . . Rms_{N} are lower than respective predetermined thresholds (test 76):

Rms₁<Seuil(1,1)&&Rms₂<Seuil(2,1)&& . . . &&Rms_{N}<Seuil(N,1),

then the algorithm considers that the external noise is low, which necessitates an adaptation of the filter H_{FF} (block 78).

In the contrary case, i.e. if the preceding condition is not verified, a new comparison is performed (test 76′):

Rms₁<Seuil(1,2)&&Rms₂<Seuil(2,2)&& . . . &&Rms_{N}<Seuil(N,2)

with higher thresholds, i.e. Seuil(1,2)>Seuil(1,1), Seuil(2,2)>Seuil(2,1) . . . Seuil(N,2)>Seuil(N,1).

If the latter test is positive, then the filter H_{FF} is modified (block 78′), but with parameters different from the preceding case.

In the negative, the algorithm continues iteratively in the same way (test 76″, block 78″ etc.), with progressively higher thresholds.

It is then possible to determine X configurations of filter H_{FF}, corresponding to as many levels/types of external noise, the algorithm choosing the optimum filter H_{FF} among the X selectable filters for the feedforward branch 58, the principle being to apply a feedforward filter introducing an imperceptible hiss while approaching the closest to the value of HFF defined by the equation (2) given hereinabove.

It will be finally noted that the technique of the invention that has just been described with its different possible implementations is perfectly compatible with other techniques acting on the transfer functions H_{FB} and/or H_{FF} of the feedback and feedforward control loops.

It is then possible to use in complement of the above-described functions of noise suppression (ANR) and anti-occlusion (AOC), a function of the “anti-plop” type, as described in the above-mentioned EP 2 930 942 A1.

This technique aims to neutralize a phenomenon that occurs during the manipulation of the headset, or when the user walks heavily or runs: the movements of the headset then create abrupt overpressures in the front cavity of the earphone. These overpressures are picked up by the internal microphone and translate into a spurious peak of the input signal of the feedback branch, with a saturation of the filter producing as an output by the transducer an audible signal or “plop”, disagreeable for the user.

To remedy this drawback, the DSP analyses simultaneously the microphone signal delivered by the internal microphone and the accelerometer signal delivered by the physiological sensor, so as to switch temporarily and selectively an anti-saturation filter provided upstream from the feedback ANC filter, so as to bring back the level of the signal applied as an input of this feedback filter to a level compatible with a normal operation of the latter. Reference may be made to the above-mentioned document for further details of implementation.

1. An audio headset, comprising two earphones (10) each including a transducer (18) for sound reproduction of an audio signal to be reproduced, this transducer being housed in an ear acoustic cavity (22), this headset comprising an active noise control system with:
an internal microphone (28), placed inside the acoustic cavity (22) and adapted to deliver a first signal (e);
an external microphone (32), placed outside the acoustic cavity (22) and adapted to deliver a second signal, and
a digital signal processor (42), comprising:
a closed-loop feedback branch (30), comprising a feedback filter (46) adapted to apply a feedback filtering transfer function H_{FB} to said first signal delivered by the internal microphone (28);
an open-loop feedforward branch (34), comprising a feedforward filter (58) adapted to apply a feedforward filtering transfer function H_{FF} to said second signal delivered by the external microphone (32); and
mixing means (54), receiving as an input the signal delivered by the feedback branch at the exit of the feedback filter (46) and by the feedforward branch at the exit of the feedforward filter (58), as well as a possible audio signal to be reproduced (M), and delivering as an output a signal adapted to pilot the transducer (18),
this audio headset further comprising means adapted to operate an anti-occlusion control and a cancellation of the passive attenuation introduced by the headset, comprising:
means (60) for detecting the voice activity of the headset user, adapted to discriminate between a situation of presence and a situation of absence of voice activity of the headset user; and
means (60) for dynamic switching, selectively as a function of the current result of the voice activity detection, between two couples of different transfer functions {H_{FB},H_{FF}} applied to the feedback (46) and feedforward (58) filters,
characterized in that:
in the absence of voice activity, the parameters of the feedforward filtering transfer function (H_{FF2}) applied to the feedforward filter (58) by the dynamic switching means to operate said cancellation of the passive attenuation are chosen so as to provide, in a range of frequencies comprised at least between 100 and 300 Hz, a first feedforward filtering gain lower than a second feedforward filtering gain of the feedforward filtering transfer function (H_{FF1}) applied to the feedforward filter (58) by the dynamic switching means to operate said anti-occlusion control in the presence of voice activity, and
in the presence of vocal activity, the parameters of the feedback filtering transfer function (H_{FB1}) applied to the feedback filter (46) by the dynamic switching means to operate said anti-occlusion control are chosen so as to provide, in a range of frequencies comprised at least between 100 and 300 Hz, a first feedback filtering gain higher than a second feedback filtering gain of the feedback filtering transfer function (H_{FB2}) applied to the feedback filter (46) by the dynamic switching means in the absence of voice activity.

2. The headset of claim 1, wherein said first feedforward filtering gain in the absence of voice activity is of at most 8 dB for the frequencies below 1 kHz.

3. The headset of claim 1, wherein said second feedforward filtering gain in the presence of voice activity is of at least 10 dB in a range of frequencies comprised at least between 100 and 300 Hz.

4. The headset of claim 1, wherein said first feedback filtering gain in the presence of voice activity is of at least 15 dB in a range of frequencies comprised at least between 100 and 300 Hz.

5. The headset of claim 1, wherein said second feedback gain in the absence of voice activity is of at most 5 dB for the frequencies comprised between 200 Hz and 1 kHz.

6. The headset of claim 1, wherein the parameters of the feedforward (H_{FF2}) and feedback (H_{FB2}) filtering transfer functions applied by the dynamic switching means to the feedforward (58) and feedback (46) filters in the absence of voice activity are chosen so as to provide together, for the frequencies below 1 kHz, a hiss lower than that provided by the feedforward (H_{FF1}) and feedback (H_{FB1}) filtering transfer functions applied by the dynamic switching means in the presence of voice activity.

7. The headset of claim 6, wherein the parameters of the feedforward (H_{FF1}) and feedback (H_{FB1}) filtering transfer functions applied by the dynamic switching means to the feedforward (58) and feedback (46) filters in the presence of voice activity are chosen so as to provide together, for the frequencies below 1 kHz, a final restitution of the external noise close to that provided by the feedforward (H_{FF2}) and feedback (H_{FB2}) filtering transfer functions applied by the dynamic switching means in the absence of voice activity, so as to avoid an audible discontinuity upon a switching.

8. The headset of claim 1, wherein:
the feedforward filter (58) is one between a plurality of selectively switchable preconfigured feedforward filters; and
the digital signal processor (42) further comprises:
means (64) for analysing said first signal (e) delivered by the internal microphone (28), adapted to verify whether or not current characteristics of this first signal verify a set of predetermined criteria; and
selection means (70), adapted to select one of the preconfigured feedforward filters as a function of the result of the verification of the first set of criteria performed by the analysis means on the characteristics of the first signal (28).

9. The audio headset of claim 8, wherein the current characteristics of the first signal comprise values of energy of this first signal (Rms1, Rms2, . . . ) in a plurality of bands of frequencies (Filtre1, Filtre2, . . . ), and the predetermined criteria comprise a series of respective thresholds (Seuil(1,1), Seuil(2, 1), . . . ) with which are compared said values of energy.

10. The audio headset of claim 9, wherein:
the set of predetermined criteria further comprises a criterion of presence or not of an audio signal (M) to be reproduced; and
two different series of said respective thresholds are provided, with which are compared said values of energy, one or the other of these two series being selected (74, 74′) according to whether an audio signal to be reproduced is present or not.
